(19) United States
(12) Patent Application Publication
(10) Pub. No.: US 2008/0088235 A1
(43) Pub. Date: Apr. 17, 2008

(54) PLASMA DISPLAY PANEL

(75) Inventors: Jongwoon Bae, Gumi-si (KR); Kirack Park, Gyeongsangbuk-do (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 11/623,976

(22) Filed: Jan. 17, 2007

(30) Foreign Application Priority Data
Oct. 16, 2006 (KR) 10-2006-0100545

(51) Int. Cl. H01J 17/49

(52) U.S. Cl. 313/582

(57) ABSTRACT

A plasma display panel is provided. The plasma display panel includes a front substrate, a rear substrate and a barrier rib, the barrier rib includes a first portion of the barrier rib where the height of the barrier rib gradually changes and a second portion of the barrier rib where the height of the barrier rib remains substantially constant.

This Nonprovisional application claims priority under 35 U.S.C. § 119(a) on Patent Application No. 10-2006-0100545 filed in Korea on Oct. 16 2006, filed in Korea on the entire contents of which are hereby incorporated by reference.

### BACKGROUND

1. Field

The present invention relates to a plasma display panel.

2. Background of the Related Art

A plasma display panel has a phosphor layer positioned inside discharge cells partitioned by barrier ribs and a plurality of electrodes applied a driving pulse such that it is emitted light inside the discharge cells.

The driving pulse applied to the plurality of electrodes generates vacuum ultraviolet rays inside the discharge cells and the vacuum ultraviolet rays display an image on the screen of the plasma display panel.

### SUMMARY OF THE DISCLOSURE

In one aspect, a plasma display panel includes a front substrate, a rear substrate and a barrier rib, the barrier rib includes a first portion of the barrier rib where a height of the barrier rib gradually changes and a second portion of the barrier rib where the height of the barrier rib remains substantially constant.

In another aspect, a plasma display panel includes a front substrate, a rear substrate and a barrier rib, the barrier rib includes a first barrier rib and a second barrier rib of a height lower than a height of the first barrier rib, for intersecting the first barrier rib, both the first barrier rib and the second barrier rib include a first portion of the barrier rib where a height of the barrier rib gradually changes and a second portion of the barrier rib where the height of the barrier rib remains substantially constant, respectively.

In still another aspect, a plasma display panel includes a front substrate, a rear substrate and a barrier rib, the barrier rib includes a first barrier rib and a second barrier rib of a height lower than a height of the first barrier rib, for intersecting the first barrier rib, both the first barrier rib and the second barrier rib include a first portion of the barrier rib where a height of the barrier rib gradually changes and a second portion of the barrier rib where the height of the barrier rib remains substantially constant, respectively, a layer a layer which is darker than a color of the barrier rib formed on an upper portion of the second portion.

Implementations may include one or more of the following features. For example, It is to be understood that both the foregoing general description and the following detailed description are exemplary and explanatory and are intended to provide further explanation of the invention as claimed.

### BRIEF DESCRIPTION OF THE DRAWINGS

The invention will be described in detail with reference to the following drawings in which like numerals refer to like elements.

FIG. 1 illustrates a structure of a plasma display panel according to one embodiment.

FIG. 2 illustrates a structure of a plasma display panel according to one embodiment.

FIG. 3a to FIG. 3c illustrates a structure of barrier rib according to one embodiment.

FIG. 4 illustrates a phosphor layer formed inside the discharge cell of a plasma display panel according to one embodiment.

FIGS. 5a and 5b illustrate a structure of electrode of a plasma display panel according to one embodiment.

FIG. 6 illustrates one form of barrier rib according to one embodiment.

FIG. 7a to FIG. 7d illustrates a dispensing characteristic of a paste of phosphor according to one embodiment.

FIG. 8a and FIG. 8b illustrate another form of barrier rib according to one embodiment.

FIG. 9 illustrates a method for representing a gray level of an image in the plasma display panel according to one embodiment.

FIG. 10 illustrates a driving waveform supplied during one subfield when driving the plasma display panel according to one embodiment.

FIGS. 11a and 11b illustrate modifications of a rising signal and a second falling signal of FIG. 10.

FIG. 12 illustrate a modification of a sustain signal of FIG. 10.

### DESCRIPTION OF SPECIFIC EMBODIMENTS

A plasma display panel of the present invention will be described below with reference to the accompanying drawings.

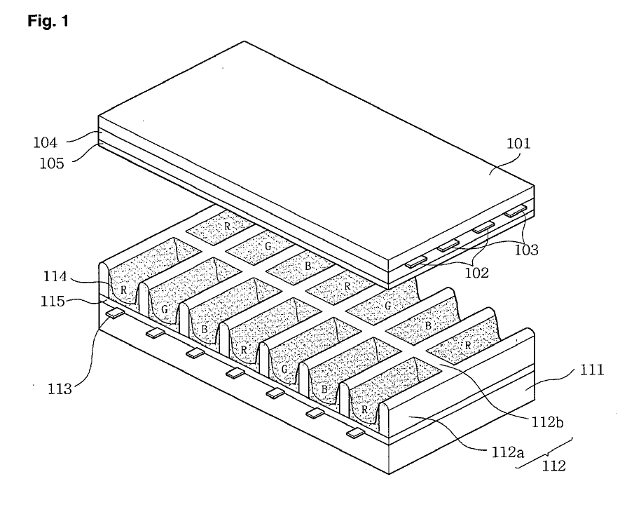

FIG. 1 illustrates the structure of a plasma display panel according to one embodiment.

Referring to FIG. 1, a plasma display panel includes a front substrate 101 and a rear substrate 111 which are coalesced with each other. On the front substrate 101, a first electrode 102 and a second electrode 103 are formed in parallel to each other. On the rear substrate 111, a third electrode 113 is formed to intersect the first electrode 102 and the second electrode 103.

The upper dielectric layer 104 for covering the first electrode 102 and the second electrode 103 is formed on an upper portion of the front substrate 101 on which the first electrode 102 and the second electrode 103 are formed.

The upper dielectric layer 104 limits discharge currents of the first electrode 102 and the second electrode 103, and the upper dielectric layer 104 provides insulation between the first electrode 102 and the second electrode 103.

A protective layer 105 is formed on an upper surface of the upper dielectric layer 104 to facilitate discharge conditions. The protective layer 105 may be formed by deposing a material such as magnesium oxide (MgO) on an upper portion of the upper dielectric layer 104.

A lower dielectric layer 115 for covering the third electrode 113 is formed on an upper portion of the rear substrate 111 on which the third electrode 113 is formed. The lower dielectric layer 115 provides insulation of the third electrode 113.

Barrier ribs 112 are formed on an upper portion of the lower dielectric layer 115 to partition discharge cells.

A phosphor (i.e., red phosphor, green phosphor, blue phosphor) is formed inside the discharge cells to display colors.

In addition to the red (R), green (G), and blue (B) phosphors, a white (w) phosphor or a yellow (Y) phosphor may be further formed inside the discharge cells.

A structure of discharge cells in which is formed by barrier ribs may be a various type such as stripe type, a well type, a delta type, a honey type.

Both pitches of the red (R), green (G), and blue (B) discharge cells may be substantially equal to one another and each of the pitch of discharge cells may be controlled so as to improve a user's visibility when it is displayed an image on the screen of a plasma display panel.

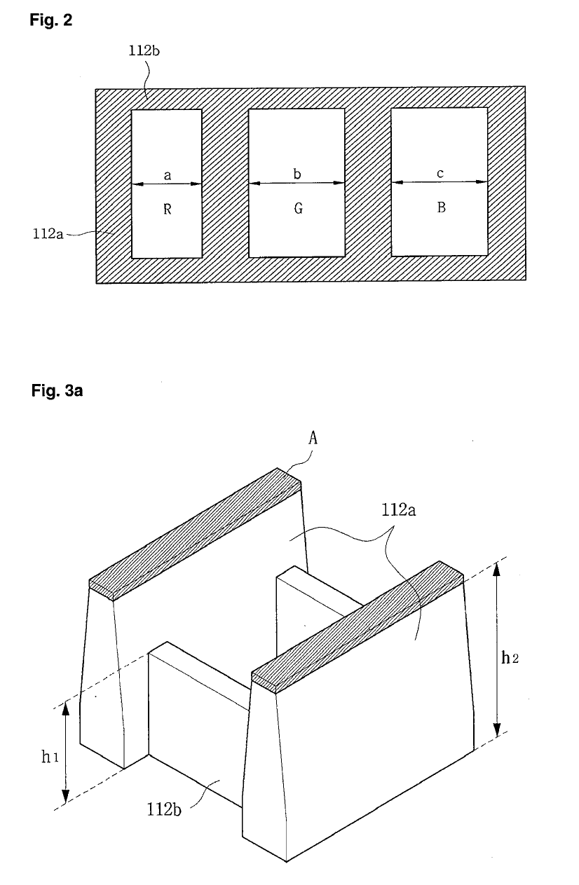

In this case, as illustrated in FIG. 2, the pitches of all of the red (R), green (G), and blue (B) discharge cells may be different from one another, or alternatively, the pitch of two discharge cells of the red (R), green (G), and blue (B) discharge cells may be different from the pitch of the remaining one discharge cell.

The plasma display panel according to one embodiment may have various forms of barrier rib structures as well as a structure of the barrier rib 112 illustrated in FIG. 1.

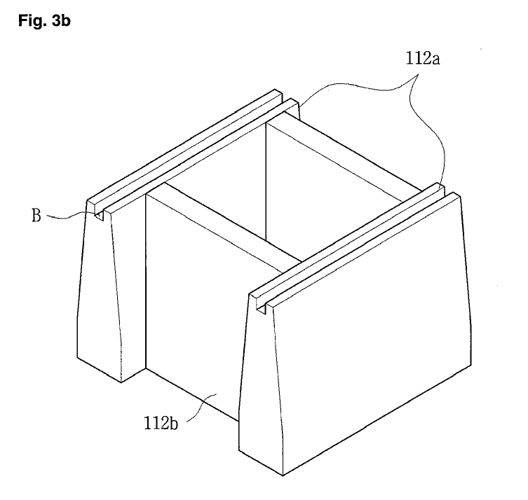

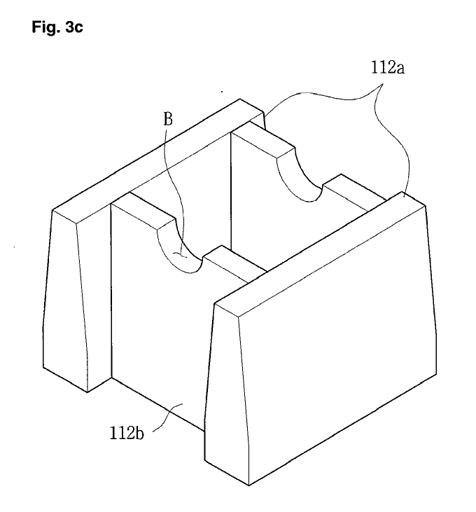

FIG.3a to FIG. 3c illustrates a structure of barrier rib according to one embodiment.

Referring to FIG. 3a, the barrier rib 112 includes a first barrier rib 112a and a second barrier rib 112b. The height (h1) of the first barrier rib 112a and the height (h2) of the second barrier rib 112b are different from each other.

In this case, if a height of the first barrier rib 112a is more than a height of the second barrier rib 112b, the first barrier rib 112a partitions the discharge cells which contain a different phosphor therein and the second barrier rib 112b partitions the discharge cells which contain a same phosphor therein, respectively.

And thus, the structure of barrier rib improves a characteristic of exhaust of a plasma display panel when the plasma display panel is manufactured and prevents a color of phosphor in one discharge cell from being mixed by a phosphor in another discharge cell when the phosphor is formed into the discharge cell.

Furthermore, a layer A which is darker than the color of the first barrier ribs 112a may be formed on an upper portion of the first barrier rib 112a to absorb a ray of light incident from outer space of the plasma display panel.

As a result, a characteristic of contrast is improved.

An area of the layer A, which is formed on the upper portion of the first barrier rib 112a, corresponds to an active area which is displayed an image.

The layer A both may be joined to the first barrier rib 112a and may be formed on the upper portion of the first barrier rib 112a independently.

The layer A may be formed by using various methods. The one of the various methods is ‘Laminating’.

A difference of the height of the first barrier rib 112a and the height of the second barrier rib 112b ranges from 10 μm to 35 μm in the active area which is displayed an image.

And thus, when the plasma display panel has the barrier ribs 112a, 112b which have a different height each other in the critical value of the difference of the height between the barrier ribs 112a, 112b, the plasma display panel has a characteristic of exhaust improved as well as a strong property of barrier rib improved.

Referring to FIG. 3b, a groove is formed in at least one of the upper portion of the first barrier rib 112a and the upper portion of the second barrier rib 112b in direction of the length of barrier rib.

As a result, a structure of the barrier rib improves a characteristic of exhaust of the plasma display panel.

Referring to FIG. 3c, a groove is formed in at least one of the upper portion of the first barrier rib 112a and the upper portion of the second barrier rib 112b in direction of the width of barrier rib.

And thus, a structure of the barrier rib also improves a characteristic of exhaust of the plasma display panel.

when the plasma display panel has the barrier ribs 112a, 112b which have a different height each other in the critical value of the difference of the height between the barrier ribs 112a, 112b, the plasma display panel has a characteristic of exhaust improved as well as a strong property of barrier rib improved.

Although the barrier rib 112 is formed over the rear substrate 111 in the embodiment of the invention, the barrier rib 112 may be formed over the front substrate 101 of the plasma display panel.

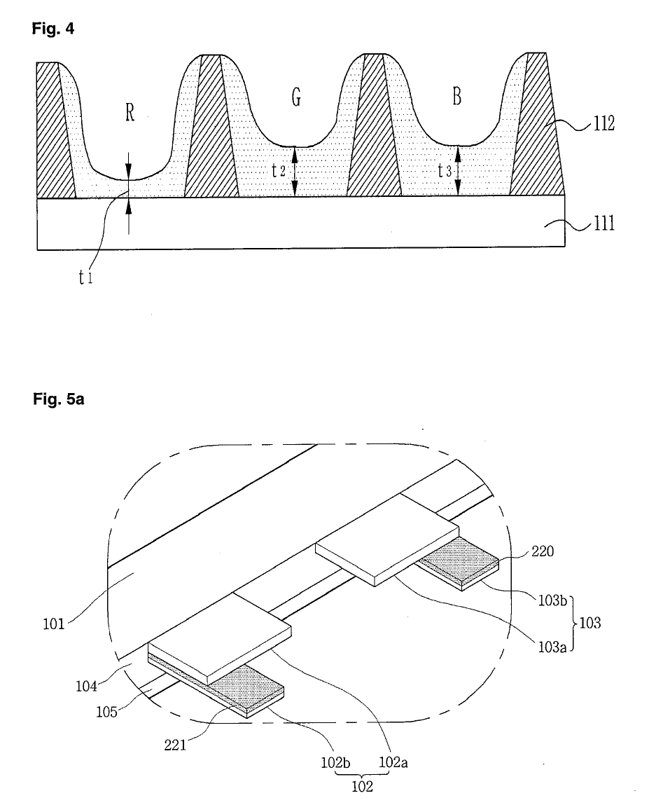

FIG. 4 illustrates a phosphor layer formed inside the discharge cell of a plasma display panel according to one embodiment.

Referring to FIG. 4, at least one of the thickness of the red phosphor (R), the thickness of green phosphor (G) and the thickness of blue phosphor (B) is different from one of the remaining phosphor.

In this case, the thickness of the red phosphor may be less than each thickness of the green phosphor and the blue phosphor. Furthermore, the thickness of the green phosphor may be substantially equal to or may be different from the thickness of the blue phosphor.

It must be noted that only one example of the plasma display panel according to one embodiment has been illustrated and described above, and the embodiment is not limited to the plasma display panel of the above-described structure. For instance, although the above description illustrates a case where the upper dielectric layer 104 and the lower dielectric layer 115 each are formed in the form of a single layer, at least one of the upper dielectric layer 104 and the lower dielectric layer 115 may be formed in the form of a plurality of layers.

A black layer (not shown) for absorbing external light may be further formed on the upper portion of the barrier ribs 112 to prevent the reflection of the external light caused by the barrier ribs 112.

Further, a black layer (not shown) may be further formed at a predetermined position on the front substrate 201 corresponding to the barrier ribs 112

The third electrode 113 formed on the rear substrate 211 may have a substantially constant width or thickness. Further, the width or thickness of the third electrode 113 inside the discharge cell may be different from the width or thickness of the third electrode 113 outside the discharge cell. For instance, the width or thickness of the third electrode 113 inside the discharge cell may be more than the width or thickness of the third electrode 113 outside the discharge cell.

In this way, the structure of the plasma display panel of the plasma display apparatus according to one embodiment may be changed in various ways.

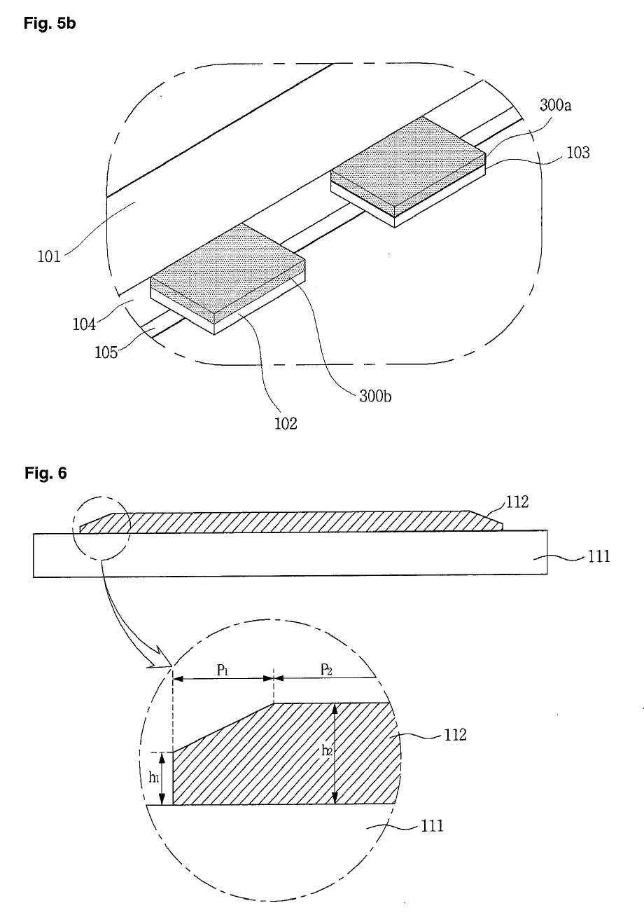

FIGS. 5a and 5b illustrate a structure of electrode of a plasma display panel according to one embodiment.

Referring to FIG. 5a, each of the first electrode 102 and the second electrode 103 includes a plurality of electrodes.

For instance, each of the first electrode 102 and the second electrode 103 includes bus electrodes 102b and 103b and transparent electrodes 102a. To emit light generated inside the discharge cells to the outside and secure the driving efficiency, the bus electrodes 102b and 103b include a material with high electrical conductivity such as silver (Ag), and the transparent electrodes 102a and 103a include a transparent material such as indium-tin-oxide (ITO).

When each of the first electrode 102 and the second electrode 103 includes the bus electrodes 102b and 103b and the transparent electrodes 102a and 103a, each of black layers 220 and 221 may be further formed between the bus electrode 102b and 103b and the transparent electrode 102a and 103a to prevent the reflection of external light caused by the bus electrodes 102b and 103b.

Referring to FIG. 5b, each of the first electrode 102 and the second electrode 103 consists of one electrode.

Each of the first electrode 102 and the second electrode 103 may contain an opaque and conductive materials such as silver (Ag), copper (Cu), aluminum (Al) or contain an transparent materials such as indium tin oxide (ITO).

And thus, it is easy to manufacture the first electrode 102 and the second electrode 103 such that the manufacturing cost is reduced.

The first electrode 102 and the second electrode 103 may be darker than a color of the upper dielectric layer 104.

Each of black layers 300a, 300b may be formed between the first electrode 102 and the front substrate 101 and between the second electrode 103 and the front substrate 101, respectively.

In this case, each of black layers 300a, 300b includes ruthenium (Ru) with dark color

And thus, the black layers 300a, 300b prevent the first electrode 102 and the electrode 103 from changing a characteristic of the electrodes 102, 103. (i.e., it is defined that the changing of a characteristic of the electrode as migration phenomenon of an electrode.) Furthermore, the black layers 300a, 300b decrease a reflection ratio of a ray of light incident from outer space of the plasma display panel such that a characteristic of contrast is improved.

FIG. 6 illustrates one form of barrier rib according to one embodiment.

Referring to FIG. 6, the barrier rib 112 formed on the whole of the rear substrate 111 include a first portion P1 of the barrier rib 112 where the height of the barrier rib gradually changes and a second portion P2 of the barrier rib 112 where the height of the barrier rib remains substantially constant.

The first portion of the barrier rib may be at least one side of the barrier rib and an edge of the first portion of the barrier rib may be rounded or a bent.

An area of the first portion P1 of the barrier rib 112 corresponds to a dummy area where does not displayed an image and an area of the second portion P2 of the barrier rib 112 corresponds to active area where is displayed an in the rear substrate 111.

A minimum height hi of the first portion P1 of the barrier rib 112 ranges from 10% to 90% of a height h2 of the second portion P2 of the barrier rib 112.

And thus, when the plasma display panel is manufactured in a critical height of the barrier rib, a dispensing characteristic of a paste of phosphor is improved.

Furthermore, the minimum height h1 of the first portion P1 of the barrier rib 112 may range from 40% to 70% of a height h2 of the second portion P2 of the barrier rib 112. And thus, when the plasma display panel is manufactured in a critical height of the barrier rib, a dispensing characteristic of a paste of phosphor is more improved.

A length of the first portion P1 of the barrier rib 112 ranges from about 0.1 mm to about 10 mm.

And thus, when the plasma display panel is manufactured in a critical length of the barrier rib, the plasma display panel maintains a sufficient active area.

The length of the first portion may range from about 0.5 mm to about 4 mm.

And thus, when the plasma display panel is manufactured in a critical length of the barrier rib, the plasma display panel maintains a sufficient active area well.

A reduction ratio in the height of the first portion of the barrier rib may range from 0.01 μm to 0.1 μm per a length of 1 μm.

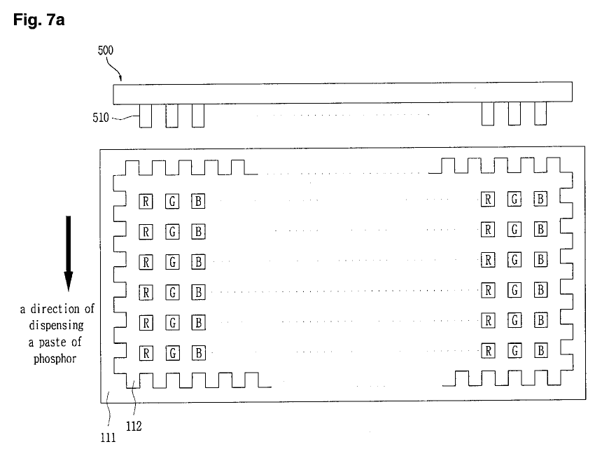

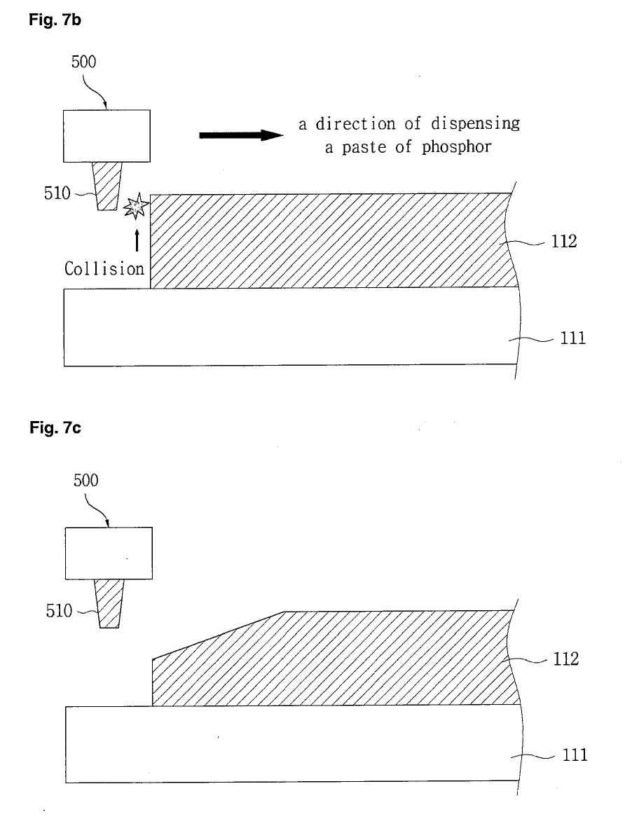

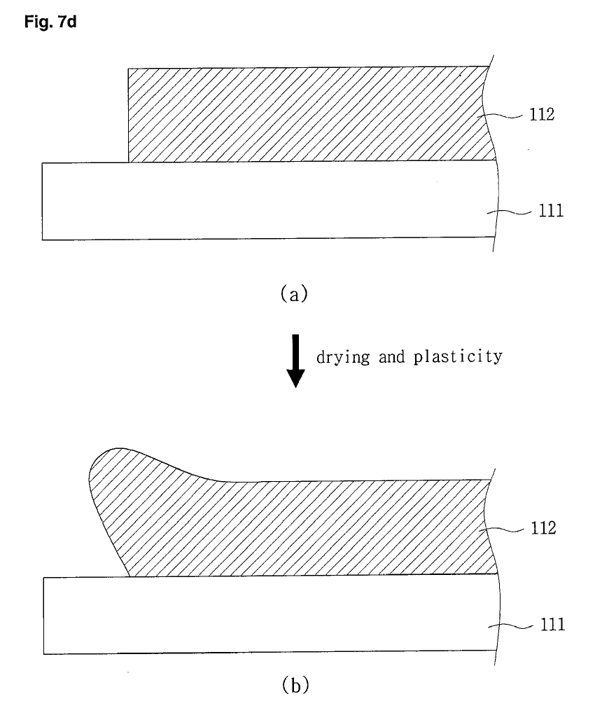

FIGS. 7a and 7b illustrate a dispensing characteristic of a paste of phosphor according to one embodiment.

Referring to FIG. 7a, a phosphor layer is formed by using various methods. The one of the various methods is a ‘Dispensing’ which use a dispensing apparatus 500.

The dispensing apparatus dispenses the paste of a phosphor through a nozzle 510 into discharge cells which is partitioned by barrier rib 112.

After that, the paste of the phosphor is dried and plasticized. As a result, the phosphor layer is formed.

As described in FIG. 7b, if the height of the whole barrier rib remains substantially constant, the nozzle 510 of the dispensing apparatus 500 collides with the barrier rib 112 while the dispensing apparatus works.

As a result, it is difficult for the paste of the phosphor to dispense into the discharge cell well.

However, as described in FIG. 7c according to one embodiment of the invention, when the height of a side portion of the barrier rib 112 gradually changes, the nozzle 510 of the dispensing apparatus 500 does not collides with the barrier rib 112 while the dispensing apparatus works.

According to, it is easy for the dispensing apparatus 500 to perform a process of a forming phosphor into the discharge cell.

Furthermore, as described in FIG. 7d (a), if a material of the barrier rib 112 is stacked on the rear substrate 111 with the same height throughout the whole rear substrate 111, after the material of the barrier rib is dried and plasticized, the material of the barrier rib 112 is modified into barrier rib which has a protruding portion in the side portion thereof as described in FIG. 7d (b).

A plasma display panel is generated a noise or a vibration by the structure of barrier rib 112 like FIG. 7d (b) when the plasma display panel is driven.

However, as described in FIG. 7c according to one embodiment of the invention, if the material of the barrier rib 112 is stacked on the rear substrate 111 to gradually decrease the height of a material of the barrier rib in the side portion of the barrier rib, after the material of the barrier rib is dried and plasticized, the modified barrier rib does not have a protruding portion in the side portion thereof as described in FIG. 7d (b).

The modified barrier rib(not shown) has an edge portion of the modified barrier rib which is bent.

As a result, a plasma display panel including the barrier rib does not generate a noise or a vibration when the plasma display panel is driven.

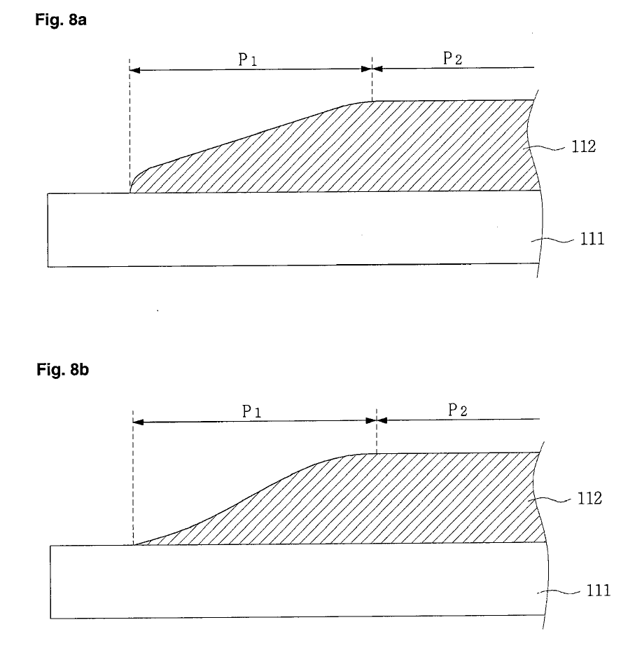

FIGS. 8a and 8b illustrate another form of barrier rib according to one embodiment.

As described in FIG. 8a and FIG. 8b, an edge of the first portion P1 of the barrier rib 112 is rounded or the height of the first portion P1 of the barrier rib 112 converge on zero 0.

The barrier rib 112 which may includes the first barrier rib 112a and the second barrier rib 112b includes less than 1000 ppm(parts per million) of plumbum (Pb) to meet a strong property of the barrier rib in various embodiments of the invention.

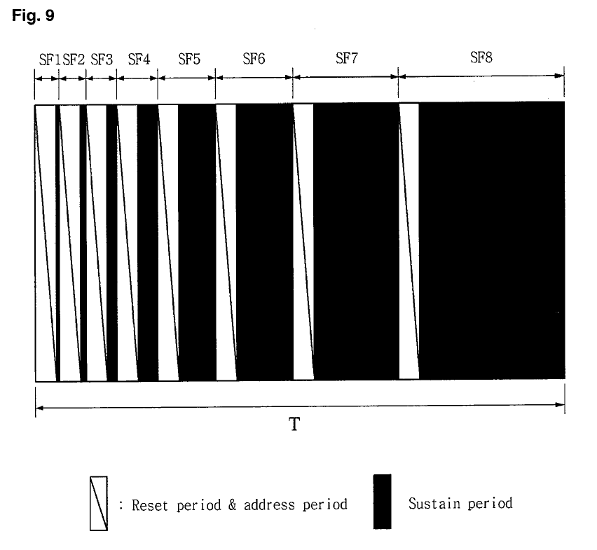

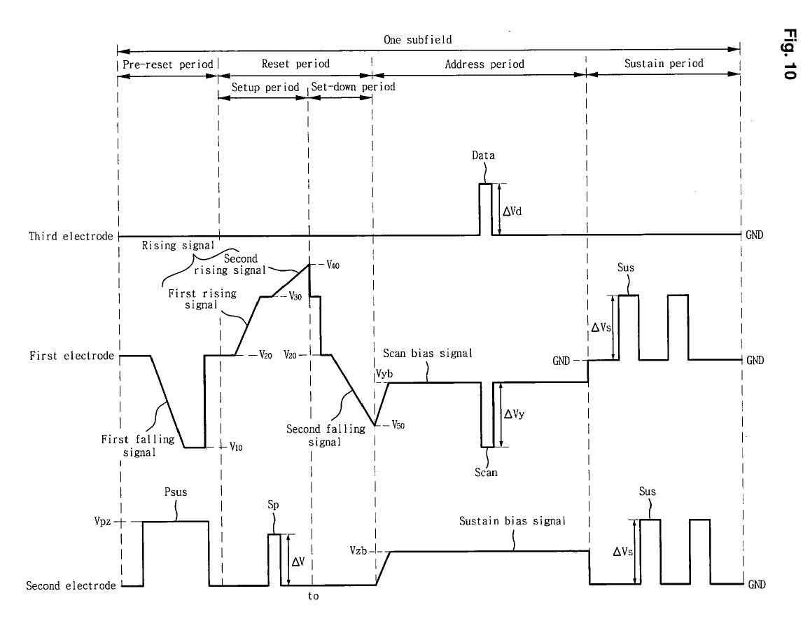

FIG. 9 illustrates a method for representing a gray level of an image in the plasma display panel according to one embodiment.

Referring to FIG. 9, in the plasma display panel according to one embodiment, a frame is divided into several subfields having a different number of emission times.

Each subfield is subdivided into a reset period for initializing all the discharge cells, an address period for selecting cells to be discharged, and a sustain period for representing gray level in accordance with the number of discharges.

The number of subfields constituting one frame may vary with a gray level to be represented.

For example, if an image with 256-level gray level is to be displayed, the frame is divided into 8 subfields SF1 to SF8. The number of sustain signals supplied during a sustain period of each subfield determines gray level weight in each subfield.

For example, in such a method of setting gray level weight of a first subfield to 2⁰ and setting gray level weight of a second subfield to 2¹, the sustain period increases in a ratio of 2ⁿ (where, n=0, 1, 2, 3, 4, 5, 6, 7) in each of the subfields. Since the sustain period varies from one subfield to the next subfield, a specific gray level is achieved by controlling the sustain period which are to be used for discharging each of the selected cells, i.e., the number of sustain discharges that are realized in each of the discharge cells.

Although FIG. 9 has illustrated and described the subfields arranged in increasing order of gray level weight, the subfields may be arranged in decreasing order of gray level weight, or the subfields may be arranged regardless of gray level weight.

FIG. 10 illustrates a driving waveform supplied during one subfield when driving the plasma display panel according to one embodiment.

Referring to FIG. 10, during a pre-reset period prior to a reset period, a first falling signal is supplied to a first electrode Y. During the supplying of the first falling signal to the first electrode Y, a pre-sustain signal (Psus) of a polarity opposite a polarity of the first falling signal is supplied to a second electrode Z.

The first falling signal supplied to the first electrode Y gradually falls to a first voltage V10.

A voltage Vpz of the pre-sustain signal (Psus) is substantially equal to a voltage Vs of a sustain signal (Sus) which will be supplied during a sustain period.

As above described, the first falling signal is supplied to the first electrode Y and the pre-sustain signal is supplied to the second electrode Z during the pre-reset period such that wall charges of a predetermined polarity are accumulated on the first electrode Y and wall charges of a polarity opposite the polarity of the wall charges accumulated on the first electrode Y are accumulated on the second electrode Z. For example, wall charges of a positive polarity are accumulated on the first electrode Y, and wall charges of a negative polarity are accumulated on the second electrode Z.

As a result, the initialization of all the discharge cells formed in the plasma display panel is stably performed during the reset period which follows the pre-reset period.

Further, even if a rising signal having a relatively low voltage is supplied to the first electrode Y during the reset period, the initialization of all the discharge cells is stably performed.

A first subfield in a plurality of subfields of one frame may include a pre-reset period prior to a reset period. The first and second subfields or the first, second and third subfields in the plurality of subfields may include a pre-reset period prior to a reset period.

Each subfield may not include the pre-reset period.

During the reset period which follows the pre-reset period, a rising signal and a second falling signal are supplied to the first electrode Y and a positive polarity signal (Sp) is supplied to the second electrode Z.

The rising signal includes a first rising signal and a second rising signal. The first rising signal gradually rises from a second voltage V20 to a third voltage V30 with a first slope, and the second rising signal gradually rises from the third voltage V30 to a fourth voltage V40 with a second slope.

The second slope of the second rising signal is gentler than the first slope of the first rising signal. When the second slope is gentler than the first slope, the quantity of light generated by a setup discharge is reduced such that contrast of the plasma display apparatus is improved.

The positive polarity signal (Sp) is supplied to the second electrode Z during the supplying of the rising signal or before an end time point of the rising signal.

It may be that the width of the positive polarity signal (Sp) is smaller than the width of a sustain signal having the widest width in the plurality of sustain signals supplied to at least one of the first electrode or the second electrode during the sustain period.

A magnitude (ΔV) of a voltage of the positive polarity signal (Sp) is substantially equal to a magnitude (ΔVs) of the voltage of the sustain signal (Sus) supplied to at least one of the first electrode or the second electrode during the sustain period. During a setup period of the reset period, the rising signal generates a weak setup discharge inside the discharge cells, thereby accumulating a predetermined amount of wall charges inside the discharge cells.

The positive polarity signal (Sp) reduces the amount of wall charges excessively accumulated inside the discharge cells, thereby reducing the generation of an erroneous discharge during the address period and the sustain period.

During a set-down period of the reset period, the second falling signal of a polarity opposite a polarity of the rising signal is supplied to the first electrode Y.

The second falling signal gradually falls from the second voltage V20 to a fifth voltage V50. The second falling signal generates a weak erase discharge (i.e., a set-down discharge) inside the discharge cells. Furthermore, the remaining wall charges are uniform inside the discharge cells to the extent that an address discharge can be stably performed.

During the address period, a scan bias signal, which gradually rises from the fifth voltage V50 to a voltage Vyb and then is maintained at the voltage Vyb, is supplied to the first electrode Y. A scan signal (Scan), which falls from the voltage Vyb of the scan bias signal by a scan voltage magnitude Avy, is supplied to all the first electrodes Y1 to Yn.

In this case, the width of the scan signal (Scan) may vary from one subfield to the next subfield. For example, the width of a scan signal in a subfield may be more than the width of a scan signal in the next subfield.

When the scan signal (Scan) is supplied to the first electrode Y, a data signal (Data) corresponding to the scan signal (Scan) is supplied to the third electrode X. The data signal (Data) rises from a ground level voltage GND by a data voltage magnitude Avd.

As the voltage difference between the scan signal (Scan) and the data signal (Data) is added to the wall voltage generated during the reset period, the address discharge occurs within the discharge cells to which the data signal (Data) is supplied.

A sustain bias signal is supplied to the second electrode z during the address period to prevent the generation of the unstable address discharge.

The sustain bias signal is supplied to the second electrode Z after the passage of a predetermined duration of time from the supplying of the positive polarity signal (Sp). In this case, a duration of time ranging from an end time point of the supplying of the positive polarity signal (Sp) to a start time point of the supplying of the sustain bias signal is longer than the width of the positive polarity signal (Sp).

When the width of the positive polarity signal (Sp) is set to a, and the duration of time ranging from the end time point of the supplying of the positive polarity signal (Sp) to the start time point of the supplying of the sustain bias signal is set to b, a ratio (b/a) of “b” to “a” is more than 1 and is equal to or less than 10. In this case, stable discharges occur during the reset period and the address period.

A supply time point of the sustain bias signal may correspond to a supply time point of the scan bias signal. Although it is not illustrated in the attached drawings, the sustain bias signal may be supplied to the second electrode Z during the set-down period or near the beginning of the address period.

A voltage Vzb of the sustain bias signal is lower than the voltage of the sustain signal which will be supplied during the sustain period, and is higher than the ground level voltage GND. Further, the voltage Vzb of the sustain bias signal is lower than the positive polarity signal (Sp).

During the sustain period, a sustain signal (Sus) is alternately supplied to the first electrode Y and the second electrode Z.

As the wall voltage within the discharge cell selected by performing the address discharge is added to a sustain voltage Vs of the sustain signal (Sus), every time the sustain signal (Sus) is supplied, a sustain discharge, i.e., a display discharge occurs between the first electrode Y and the second electrode Z.

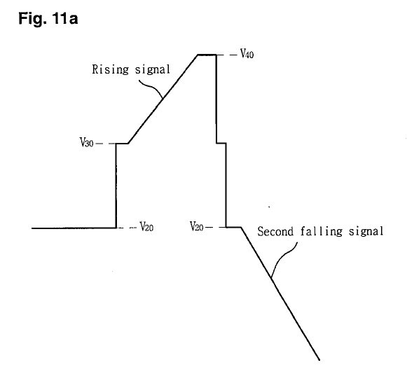

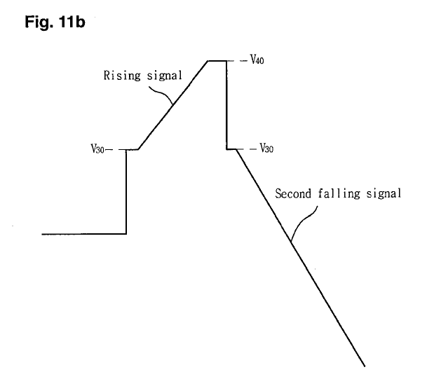

FIGS. 11a and 11b illustrate modifications of a rising signal and a second falling signal of FIG. 10.

Referring to FIG. 11a, the rising signal sharply rises to the third voltage V30, and then gradually rises from the third voltage V30 to the fourth voltage V40.

As above, the slope of the rising signal may vary.

Referring to FIG. 11b, the second falling signal gradually falls from the third voltage V30.

a voltage falling time point of the second falling signal is changeable.

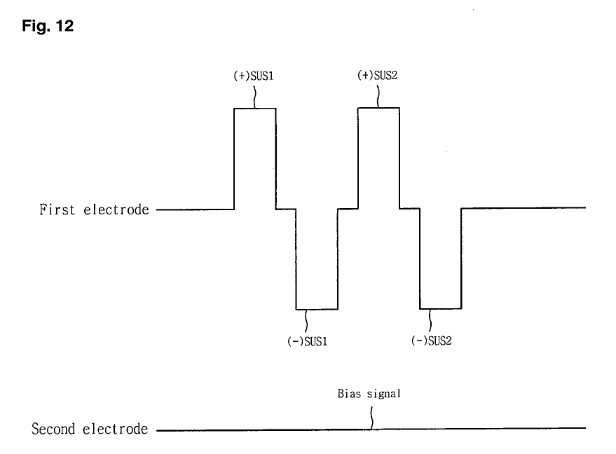

FIG. 12 illustrate a modification of a sustain signal of FIG. 10.

Referring to FIG. 12, when sustain signals (+SUS1 and +SUS2) of a positive polarity and sustain signals (−SUS1 and −SUS2) of a negative polarity are alternately supplied to the first electrode Y, a bias signal is supplied to the second electrode Z. On the contrary, during the supplying of a bias signal to the first electrode Y, a sustain signal of a positive polarity and a sustain signal of a negative polarity may be alternately supplied to the second electrode Z.

The bias signal is maintained at the ground level voltage GND.

when the sustain signal is supplied to either the first electrode Y or the second electrode Z, a single diving board for driving the first electrode Y and the second electrode Z during the sustain period may be installed.

Accordingly, the whole size of a driver for driving the plasma display panel is reduced such that the manufacturing cost is reduced.

The invention being thus described, it will be obvious that the same may be varied in many ways. Such variations are not to be regarded as a departure from the scope of the invention, and all such modifications as would be obvious to one skilled in the art are intended to be included within the scope of the following claims.

What is claimed is:

1. A plasma display panel, comprising:
a front substrate;
a rear substrate formed in parallel to the front substrate; and
a barrier rib for partitioning discharge cells between the front substrate and the rear substrate,
wherein the barrier rib includes a first portion of the barrier rib where a height of the barrier rib gradually changes and a second portion of the barrier rib where the height of the barrier rib remains substantially constant.

2. The plasma display panel of claim 1, wherein the first portion of the barrier rib is positioned over the rear substrate corresponding to a dummy area which does not displayed an image.

3. The plasma display panel of claim 1, wherein a minimum height of the first portion of the barrier rib ranges from 10% to 90% of a maximum height of the first portion of the barrier rib.

4. The plasma display panel of claim 3, wherein the minimum height of the first portion of the barrier rib ranges from 40% to 70% of the maximum height of the first portion of the barrier rib.

5. The plasma display panel of claim 1, wherein a length of the first portion of the barrier rib ranges from about 0.1 mm to about 10 mm.

6. The plasma display panel of claim 5, wherein the length of the first portion ranges from about 0.5 mm to about 4 mm.

7. The plasma display panel of claim 1, wherein a reduction ratio in the height of the first portion of the barrier rib ranges from 0.01 μm to 0.1 μm per a length of 1 μm.

8. The plasma display panel of claim 1, wherein the first portion of the barrier rib is at least one side of the barrier rib.

9. The plasma display panel of claim 1, wherein an edge of the first portion of the barrier rib is rounded or bent.

10. The plasma display panel of claim 1, wherein the barrier rib partitions the discharge cells, each discharge cell containing a different phosphor therein, respectively.

11. A plasma display panel, comprising:
a front substrate;
a rear substrate formed in parallel to the front substrate; and
a barrier rib for partitioning discharge cells between the front substrate and the rear substrate,
wherein the barrier rib includes a first barrier rib and a second barrier rib of a height lower than a height of the first barrier rib, for intersecting the first barrier rib,
wherein the first barrier rib includes a first portion of the barrier rib where a height of the barrier rib gradually changes and a second portion of the barrier rib where the height of the barrier rib remains substantially constant.

12. The plasma display panel of claim 11, wherein the first barrier rib partitions the discharge cells, each discharge cell containing a different phosphor therein, respectively.

13. The plasma display panel of claim 11, wherein a difference between a maximum height of the second barrier rib and a height of the second portion of the first barrier rib ranges from 10 μm to 35 μm.

14. The plasma display panel of claim 11, wherein the first portion of the barrier rib is positioned over the rear substrate corresponding to a dummy area which does not displayed an image.

15. The plasma display panel of claim 11, wherein the barrier rib, comprises less than 1000 ppm of plumbum.

16. A plasma display panel, comprising:
a front substrate;
a rear substrate formed in parallel to the front substrate; and
a barrier rib for partitioning discharge cells between the front substrate and the rear substrate,
wherein the barrier rib includes a first barrier rib and a second barrier rib of height lower than a height of the first barrier rib, for intersecting the first barrier rib,
wherein both the first barrier rib and the second barrier rib include a first portion of the barrier rib where a height of the barrier rib gradually changes and a second portion of the barrier rib where the height of the barrier rib remains substantially constant,
wherein a layer which is darker than a color of the barrier rib is formed on an upper portion of the second portion.

17. The plasma display panel of claim 16, wherein the layer is laminated on an upper portion of the second portion.

18. The plasma display panel of claim 16, wherein the layer is joined to the second portion.

19. The plasma display panel of claim 16, wherein the first barrier rib partitions the discharge cells, each discharge cell containing a different phosphor therein, respectively.

20. The plasma display panel of claim 16, wherein the first portion of the barrier rib is positioned over the rear substrate corresponding to a dummy area which does not displayed an image.
